(19) United States
(12) Patent Application Publication
(10) Pub. No.: US 2008/0218140 A1
(43) Pub. Date: Sep. 11, 2008

(54) Control apparatus for cooler

(76) Inventors: Chih-Peng Liao, Chung-Ho City (TW); Kuo-Hwa Huang, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/703,657

(22) Filed: Feb. 8, 2007

(51) Int. Cl. G05F 1/10

(52) U.S. Cl. 323/282

(57) ABSTRACT

The present invention discloses a control apparatus, which integrates the methods of PWM signal controlling and manual voltage regulating for controlling the cooler. The control apparatus includes a voltage stabilizer, a voltage regulator, and a switching unit. The voltage stabilizer connects to a CPU of a motherboard for receiving a PWM signal and outputting a stable PWM signal. The voltage regulator connects to the voltage stabilizer for regulating the voltage level of the stable PWM signal. The switching unit connects to the voltage stabilizer, the voltage regulator and the cooler for performing a switching operation between a first control mode and a second control mode. Moreover, the control apparatus controls the cooler via the stable PWM signal in the first control mode, and controls the cooler by regulating the voltage level of the stable PWM signal in the second control mode.

### BACKGROUND OF THE INVENTION

1. Field of the Invention

The present invention relates to a control apparatus and, more particularly, to a control apparatus for controlling a cooler via a PWM signal generated from a CPU and manual voltage regulating.

2. Description of Related Art

The techniques involved in semiconductor production have developed speedily. Meanwhile, integrated circuits have decreased in size while their operational speed has increased. In general, the temperature of an IC correlates with the operation of the IC. When the operation speed of an IC is high, the temperature of the IC is also high.

The major heat source in a computer case is the CPU which needs to process huge amounts of information at high speed. Therefore, it is necessary to detect the temperature in the computer case so as to avoid overheating.

In general, a computer case has a simple fan for cooling when the computer is on. But the simple fan still operates when the computer operates is in power-saving mode. Thereof, the above-mentioned design consumes unnecessary amounts of power.

With respect to the faults of the design above, a motherboard produced by Intel Corporation, which generates a PWM signal for controlling the rotational speed of the fan in response to the feedback temperature of the CPU so as to stabilize the temperature of the CPU. However, the feedback temperature of the CPU is a magnitude of a dynamic analogy, there being a temperature difference with the actual temperature of the CPU. Therefore, since the temperature is different, the PWM signal delays controlling the rotational speed of the fan.

### SUMMARY OF THE INVENTION

Accordingly, an object of the present invention is to provide a control apparatus, in which the control apparatus integrates the methods of PWM signal control and manual voltage regulating so as to improve the controlling fault of the PWM signal of the prior art.

The control apparatus of the present invention receives a PWM signal which is generated from a CPU of a motherboard so as to control a cooler.

The first embodiment of the control apparatus of the present invention includes a voltage stabilizer, a voltage regulator, and a switching unit. The voltage stabilizer connects to the motherboard for receiving the PWM signal and outputting a stable PWM signal. The voltage regulator connects to the voltage stabilizer for regulating the voltage level of the stable PWM signal. The switching unit connects to the voltage stabilizer, the voltage regulator and the cooler for performing a switching operation between a first control mode and a second control mode. Moreover, the control apparatus controls the cooler via the stable PWM signal in the first control mode, and controls the cooler by regulating the voltage level of the stable PWM signal in the second control mode.

The second embodiment of the control apparatus of the present invention includes a switching unit, a voltage regulator, and a voltage stabilizer.

The switching unit connects to the motherboard. The voltage regulator connects to the switching unit for outputting an adjustable output voltage. The voltage stabilizer connects to the switching unit and the cooler, for receiving the PWM signal via the switching unit and transmitting a stable PWM signal to the cooler, or receiving the adjustable output voltage via the switching unit and transmitting a stable adjustable output voltage to the cooler. Moreover, the switching unit is used for performing a switching operation between a first control mode and a second control mode. Furthermore, when the switching operation is in the first control mode, the switching unit transmits the PWM signal to the cooler. Moreover, when the switching operation is in the second control mode, the switching unit transmits the adjustable output voltage to the cooler.

### BRIEF DESCRIPTION OF THE DRAWINGS

The various objects and advantages of the present invention will be more readily understood from the following detailed description when read in conjunction with the appended drawing, in which:

FIG. 1 is a circuit block schematic diagram of a control apparatus of the first embodiment of the present invention; and

FIG. 2 is a circuit block schematic diagram of a control apparatus of the second embodiment of the present invention.

### DETAILED DESCRIPTION OF THE PREFERRED EMBODIMENTS

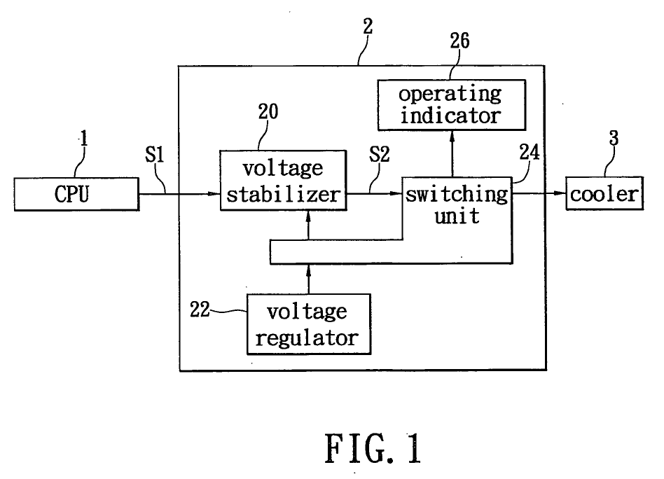

As shown in FIG. 1, a control apparatus 2 according to the first embodiment of the present invention is connected to a CPU 1 of a motherboard (not shown) and a cooler 3. The control apparatus 2 receives a PWM signal S1 generated from the CPU 1 and controls the cooler 3 in response to the PWM signal S1. The control apparatus 2 includes a voltage stabilizer 20, a voltage regulator 22, and a switching unit 24.

The voltage stabilizer 20 connects to the CPU 1 of a motherboard for receiving the PWM signal S1 and outputting a stable PWM signal S2. The voltage regulator 22 regulates the voltage level of the stable PWM signal S2. The switching unit 24 connects to the voltage stabilizer 20, the voltage regulator 22, and the cooler 3 so as to perform a switching operation between a first control mode and a second control mode. Moreover, the control apparatus 2 controls the cooler 3 via the stable PWM signal S2 in the first control mode, and controls the cooler 3 by regulating the voltage level of the stable PWM signal S2 in the second control mode.

When the control apparatus 2 is operating in the first control mode, the stable PWM signal S2 is transmitted to the cooler 3 via the switching unit 24. At this time, the operation of the cooler 3 is controlled by the magnitude of the duty cycle of the stable PWM signal S2, wherein the magnitude of the duty cycle of the stable PWM signal S2 is proportional to the temperature of the CPU 1.

When the control apparatus 2 is operating in the second control mode, the voltage regulator 22 connects to the voltage stabilizer 20 via the switching unit 24 so as to regulate the voltage level of the stable PWM signal S2. At this time, the operation of the cooler 3 is controlled by the magnitude of the duty cycle of the stable PWM signal S2 and the voltage level of the stable PWM signal S2.

Please refer to FIG. 1 again. The switching unit 24 further connects to an operating indicator 26 such as an LED, wherein the operating indicator 26 includes a red light LED (not shown) and a green light LED (not shown). Moreover, when the control apparatus 2 is operating in the first control mode, the red light LED is turned on. At this time, the cooler 3 is controlled by the magnitude of the duty cycle of the stable PWM signal S2.

When the control apparatus 2 is operating in the second control mode, the green light LED is turned on. At this time, the voltage regulator 22 is regulated by manual voltage regulating so as to regulate the voltage level of the stable PWM signal S2. Moreover, the operation of the cooler 3 is controlled by the magnitude of the duty cycle of the stable PWM signal S2 and the voltage level of the stable PWM signal S2. The magnitude of the illumination of the green light LED is in response to the voltage level of the stable PWM signal S2.

Moreover, if the cooler 3 is implemented as a fan, when the voltage level of the stable PWM signal S2 becomes higher, the rotational speed of the fan quickens, and the illumination of the green light LED gets brighter.

In the first embodiment of the present invention, the user regulates the voltage regulator 22 manually so as to accelerate the operation of the cooler 3 when the temperature of the CPU 1 is high. Later, the operation of the cooler 3 is controlled by the magnitude of the duty cycle of the stable PWM signal S2 to achieve a preferred operation.

Alternatively, the user regulates the voltage regulator 22 manually so as to slow the operation of the cooler 3. Later, the operation of the cooler 3 is controlled by the magnitude of the duty cycle of the stable PWM signal S2 to achieve a preferred operation.

Therefore, the control apparatus of the present invention improves the controlling fault of the PWM signal of the prior art and provides the user with manual voltage regulating for regulating the voltage regulator.

The cooler 3 can be a cooling fan. The cooling fan can be a CPU fan, a computer case fan, a power supply fan, a display card fan, a motherboard fan, or a cooler pump. When the computer case utilizes those cooling fans stated above, those cooling fans are controlled by the magnitude of the duty cycle of the stable PWM signal S2 and the voltage level of the stable PWM signal S2. Moreover, those cooling fans are controlled to accelerate or slow the operation so as to regulate the temperature of the computer case in response to the temperature of the CPU 1.

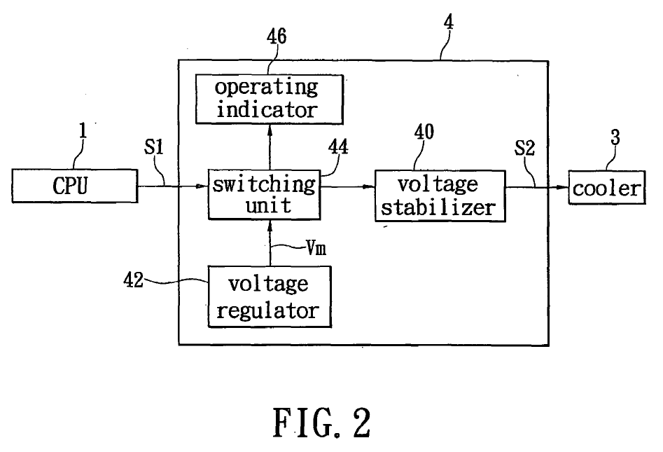

As shown in FIG. 2, a control apparatus 4 according to the second embodiment of the present invention is connected to a CPU 1 of a motherboard (not shown) and a cooler 3. The control apparatus 4 receives a PWM signal S1 generated from the CPU 1 and controls the cooler 3 in response to the PWM signal S1. The control apparatus 4 includes a voltage stabilizer 40, a voltage regulator 42, and a switching unit 44.

The switching unit 44 connects to the CPU 1 of the motherboard. The voltage regulator 42 connects to the switching unit 44 for outputting an adjustable output voltage Vm. The voltage stabilizer 40 connects to the switching unit 44 and the cooler 3 for receiving the PWM signal S1 via the switching unit 44 and transmitting a stable PWM signal S2 to the cooler 3, or for receiving the adjustable output voltage Vm via the switching unit 44 and transmitting a stable adjustable output voltage Vm to the cooler 3.

The switching unit 44 performs a switching operation between a first control mode and a second control mode. When the switching operation is in the first control mode, the switching unit 44 transmits the PWM signal S2 to the cooler 3. When the switching operation is in the second control mode, the switching unit 44 transmits the adjustable output voltage Vm to the cooler 3.

When the control apparatus 4 operates in the first control mode, the stable PWM signal S2 is transmitted to the cooler 3 via the switching unit 44. At this time, the operation of the cooler 3 is controlled by the magnitude of the duty cycle of the stable PWM signal S2, wherein the magnitude of the duty cycle of the stable PWM signal S2 is proportional to the temperature of the CPU 1.

When the control apparatus 4 operates in the second control mode, the voltage regulator 42 connects to the voltage stabilizer 40 via the switching unit 44 so as to transmit the adjustable output voltage Vm to the cooler 3. At this time, the cooler 3 is controlled by the adjustable output voltage Vm.

Please refer to FIG. 2 again, the switching unit 44 further connects to an operating indicator 46 such as an LED, wherein the operating indicator 46 includes a red light LED (not shown) and a green light LED (not shown). Moreover, when the control apparatus 4 is operating in the first control mode, the red light LED is turned on. At this time, the cooler 3 is controlled by the magnitude of the duty cycle of the stable PWM signal S2.

When the control apparatus 4 is operating in the second control mode, the green light LED is turned on. At this time, the voltage regulator 42 is regulated by manual voltage regulating so as to regulate the voltage level of the adjustable output voltage Vm. Moreover, the operation of the cooler 3 is controlled by the magnitude of the duty cycle of the stable PWM signal S2 and the voltage level of the adjustable output voltage Vm. The magnitude of the illumination of the green light LED is in response to the voltage level of the adjustable output voltage Vm.

If the cooler 3 is implemented as a fan, when the voltage level of the stable PWM signal S2 gets higher, the rotational speed of the fan increases, and the illumination of the green light LED gets brighter.

In the second embodiment of the present invention, the user operates the control apparatus 4 in the second control mode to regulate the voltage regulator 42 manually so as to accelerate the operation of the cooler 3 when the temperature of the CPU 1 is over. Alternatively, the user regulates the voltage regulator 42 manually so as to slow the operation of the cooler 3. After the user operates the control apparatus 4 in the second control mode, the user operates the control apparatus 4 in the first control mode for controlling the cooler 3 by the magnitude of the duty cycle of the stable PWM signal S2 to achieve a preferred operation.

Therefore, the control apparatus of the present invention could improve the controlling fault of the PWM signal of prior art and provide the user a manual voltage regulating for regulating the voltage regulator.

Please refer to FIG. 2 again. The cooler 3 can be a cooling fan. The cooling fan can be a CPU fan, a computer case fan, a power supply fan, a display card fan, a motherboard fan or a cooler pump. When the computer case has those cooling fans stated above, those cooling fans are controlled by the magnitude of the duty cycle of the stable PWM signal S2 and the voltage level of the adjustable output voltage Vm. Moreover, those cooling fans are controlled to accelerate or slow the operation so as to regulate the temperature of the computer case in response to the temperature of the CPU 1.

To sum up, the control apparatus of the present invention includes a voltage stabilizer, a voltage regulator and a switching unit, which integrates the methods of a PWM signal controlling and a manual voltage regulating for controlling the cooler so as to improve the controlling fault of the PWM signal of the prior art.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A control apparatus receiving a PWM signal generated from a CPU of a motherboard so as to control a cooler, the control apparatus comprising:
a voltage stabilizer connected to the motherboard for receiving the PWM signal and outputting a stable PWM signal;
a voltage regulator connected to the voltage stabilizer for regulating a voltage level of the stable PWM signal; and
a switching unit connected to the voltage stabilizer, the voltage regulator and the cooler for performing a switching operation between a first control mode and a second control mode, wherein the control apparatus controls the cooler via the stable PWM signal in the first control mode, and controls the cooler by regulating the voltage level of the stable PWM signal in the second control mode.

2. The control apparatus as claimed in claim 1 further comprising an operating indicator, wherein the operating indicator connects to the switching unit for indicating the switching operation.

3. The control apparatus as claimed in claim 2, wherein the operating indicator is an LED.

4. The control apparatus as claimed in claim 1, wherein the cooler is a cooling fan.

5. The control apparatus as claimed in claim 4, wherein the cooling fan is a CPU fan, a computer case fan, a power supply fan, a display card fan, or a motherboard fan.

6. The control apparatus as claimed in claim 1, wherein the cooler is a cooler pump.

7. A control apparatus receiving a PWM signal generated from a CPU of a motherboard so as to control a cooler, the control apparatus comprising:
a voltage regulator for outputting an adjustable output voltage;
a switching unit connected to the motherboard and the voltage regulator for performing a switching operation between a first control mode and a second control mode; and
a voltage stabilizer connected to the switching unit and the cooler for stabilizing an output signal generated from the switching unit, and transmitting the output signal to the cooler;
wherein, when the switching operation is in the first control mode, the switching unit transmits the PWM signal to the cooler; and, when the switching operation is in the second control mode, the switching unit transmits the adjustable output voltage to the cooler.

8. The control apparatus as claimed in claim 7 further comprising an operating indicator, wherein the operating indicator connects to the switching unit for indicating the switching operation.

9. The control apparatus as claimed in claim 8, wherein the operating indicator is an LED.

10. The control apparatus as claimed in claim 7, wherein the cooler is a cooling fan.

11. The control apparatus as claimed in claim 10, wherein the cooling fan is a CPU fan, a computer case fan, a power supply fan, a display card fan, or a motherboard fan.

12. The control apparatus as claimed in claim 7, wherein the cooler is a cooler pump.
